(19) United States
(12) Patent Application Publication
(10) Pub. No.: US 2002/0069058 A1
(43) Pub. Date: Jun. 6, 2002

(54) MULTIMODAL DATA INPUT DEVICE

(76) Inventors: GUO JIN, SUNNYVALE, CA (US); CHARLES YIMIN WU, SINGAPORE (SG)

Correspondence Address: MOTOROLA INC, 600 NORTH US HIGHWAY 45, LIBERTYVILLE, IL, 60048-5343, US

(21) Appl. No.: 09/347,887

(22) Filed: Jul. 6, 1999

(51) Int. Cl. G10L 15/00

(52) U.S. Cl. 704/249

(57) ABSTRACT

A voice input representing a first phonetic component of a data element is accepted through an audio input (10). A mechanical input representing at least one writing component of the data element, such as a stroke or character, is accepted through a mechanical input device (15), such as a digitizer, keypad, or other means. A desired data element is identified from the voice input and the at least one writing component.

### FIELD OF THE INVENTION

This invention relates to a method of data entry and a device for data entry.

### BACKGROUND OF THE INVENTION

For many years it has been a challenge to facilitate entry of data into devices that become smaller and smaller in the consumer market place. The standard QWERTY keyboard is a widely popular data entry device for alphanumeric text, but it has limitations when shrunk to the size of a hand held telephone or when adapted to be used for entry of Chinese and Japanese and other ideographic languages that have large character sets.

Significant efforts have been directed to data entry devices for entering Chinese and other ideographic characters using a keypad, having as few as twelve keys. Examples can be found in co-pending patent application Ser. Nos. 08/754,453 of Balakrishnan and 09/220,308 of Guo, which are assigned to the assignee of the present invention.

Data entry devices based on a pinyin representation of characters are somewhat unnatural, in that they require the user to mentally translate a character into its pinyin form before entry. Data entry devices based on a stroke representation are more natural, but a single Chinese or Japanese character can comprise many strokes and may still require many key presses for unique identification of a character or for a search of a character dictionary to a manageable sub-set of candidates.

An alternative approach to data entry is speech recognition. Speech input is very natural, and potentially offers an opportunity for high-speed data entry, but unfortunately the processing problem is highly complex. Problems with speech recognition include adapting the recognition model to many different styles and patterns of voices or requiring a lengthy training procedure to uniquely adapt a recognition process to an intended user's own voice and speaking characteristics. Additionally, speech recognition is very processor intensive and memory intensive, such that devices that are capable of good speech recognition tend to be very expensive and the process is less suited to small hand held devices with low specification processors and limited memory. Speech recognition performance on small platform devices tends to be unacceptably poor.

Speech recognition normally requires desktop computing power and a significant amount of editing after dictation. Given the limited computing and editing resources on most existing small handheld devices, it is not practical yet to deploy onto them any prevailing continuous speech recognition technologies.

However, the isolated word dictation technology, which demands less computing power, is becoming feasible on small handheld devices very soon. It will make text entry easier and more user friendly on handheld devices like a cell phone or two-way pager like we have seen on desktop platform. It is especially useful for using ideographic languages like Chinese and Japanese.

Text entry is critical to the effective use of certain content-centric functions on handheld devices, such as SMS (Short Message Service) and phone-book search on cell phone and note taking on PDA. While operating functions like SMS and phone-book search, entry of people's names and proper nouns like place names, gets very frequently involved in the process. Unfortunately, due to the limited vocabulary contained, the current isolated word dictation system is generally not capable of handling most of people's names and proper nouns. As a result, entry of people's names and proper nouns often requires the isolated word dictation system to perform recognition task at isolated character level. First, a word is split into characters and each of them is sequentially dictated into the system one by one for recognition.

Experience with isolated word Chinese dictation technology on desktop platform has already shown that the recognition accuracy at the character level is much lower than that at the word level, largely due to the severe homophone phenomena in Chinese language. In other words, although the dictation system normally can deliver fairly satisfactory results in dealing with words, it usually yields very poor results when dealing in isolated characters.

Now, we are facing such a problem, on one hand, we want to take advantage of speech recognition technologies, on the other hand, dealing with isolated charters becomes a big hurdle.

This problem can be tackled by taking two different approaches, the first uses speech only and the second uses speech with the help of a pen.

In the speech only approach, let us first recall when we speak to the airline agent of our names or destination cities over the telephone, we very often say like “John, J for Japan, O for Ohio, H for Hawaii, N for New York”, attempting to reduce possible confusions.

We can do the same when dictating isolated characters in Chinese. For example, if we want to dictate a character “yil” meaning something related to medicine or medical treatment. After we pronounce that sound “yil”, the recognition system will normally produce a list of candidates, typically containing several tens, all having the same pronunciation “yil”. If tolerance of tone in pronunciation is allowed, the list of candidates will be even longer. However, if we borrow the above idea of reducing ambiguity by saying “yil shenl de yil”, meaning “yil for medical doctor (yil shenl)”, we can expect the dictation system should be able to produce the right character for “yil ” with very high accuracy.

This scheme has several intrinsic advantages, 1) it is a very common practice when people try to make themselves clearer when engaging in conversations in Chinese, i.e., there is no learning curve required for that kind of usage; 2) it employs a very simple and fixed grammar structure, most dictation systems can readily make effective use of the embedded syntactic information; 3) the same pronunciation of the intended character is repeated twice, this helps the dictation system to reliably capture the correct acoustic representation of the spoken character.

In the second approach, if a specific character is intended, a common word containing the character is first formed and then dictated into the system. When a list of word candidates is produced and displayed, the pen is used to pick out the intended character from the word candidate list. The advantages of such a scheme are, 1) using pen for pointing and selecting is very intuitive and natural, and it is also much easier and faster than using voice; 2) the pen is used for pointing and selecting of individual character in almost the same way as used for pointing and selecting of isolated word, making the operation consistent across two different situations, for isolated words and characters as well.

There is a need for an improved method of data entry.

### BRIEF DESCRIPTION OF THE DRAWINGS

FIG. 1 is a block diagram showing elements of a data input device in accordance with a preferred embodiment of the invention.

FIG. 2 is a flow diagram illustrating operation of the search engine of FIG. 1.

### DETAILED DESCRIPTION OF THE DRAWINGS

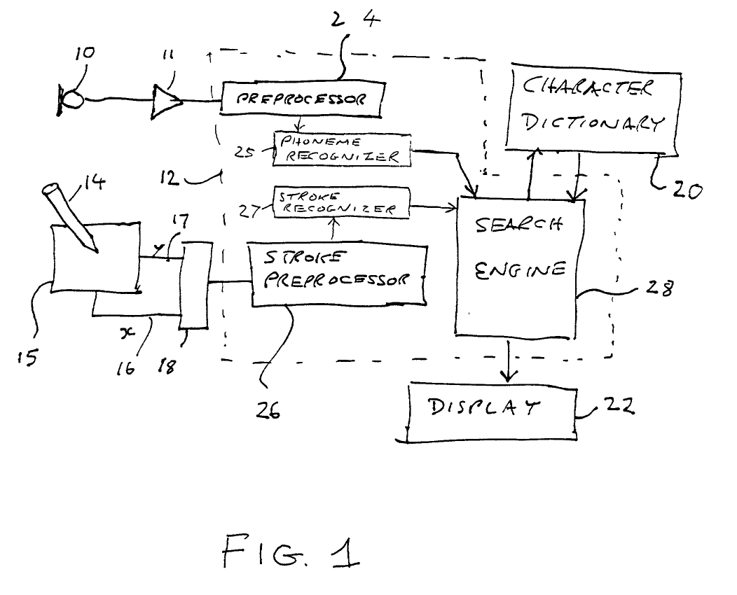

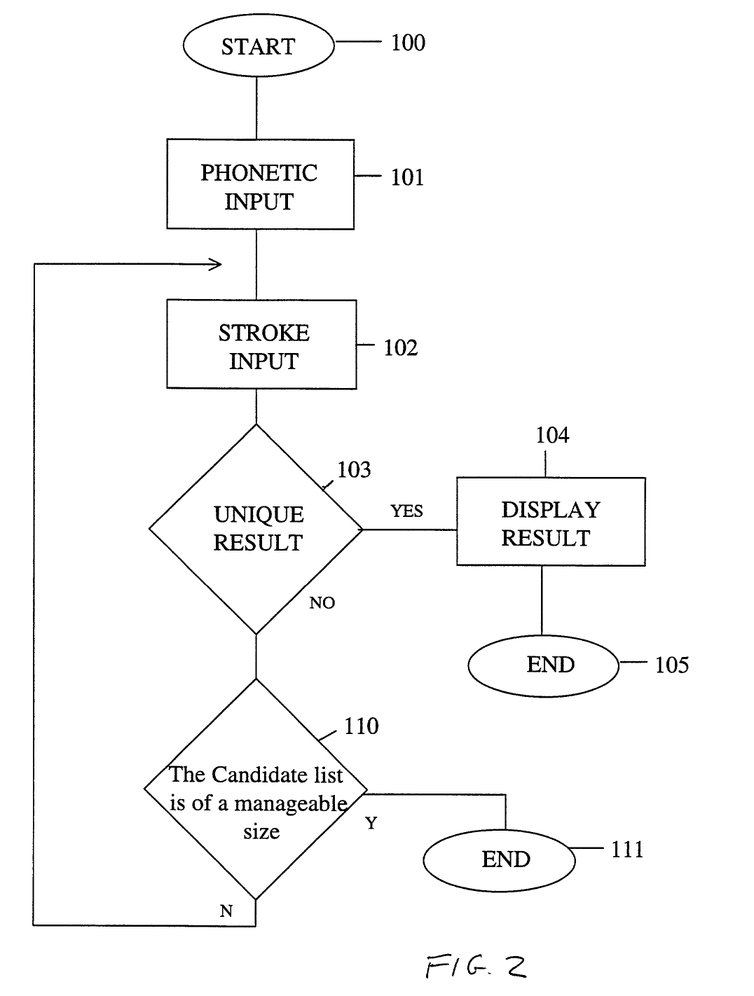

Referring to FIG. 1, a data input device is shown having a microphone 10 connected via an analog-to-digital converter 11 to a microprocessor 12. Also shown is a digitizer 15 having X and Y outputs 16 and 17 connected via an interface element 18 to the microprocessor 12. Also connected to the microprocessor 12 are a memory 20 and a display 22. The memory 20 preferably contains a character dictionary, but may contain other data as described below.

The microprocessor 12 has speech pre-processor functions 24 that receive inputs from the analog-to-digital converter 11 and stroke pre-processor functions 26 that receive inputs from the interface element 18. A syllable recognizer 25 and a stroke recognizer 27 are connected to the elements 24 and 26 respectively. A search engine 28 receives inputs from the phoneme recognizer 25 and the stroke recognizer 27 and connects with the character dictionary in memory 20 and the display 22.

In operation, a user commences entry of a data entry element such as a Chinese word by speaking into the microphone 10 and pronouncing the syllable element of the desired word. Chinese characters are all single-syllable.

The Chinese language has a set of established phonetic elements to represent its syllable (frequently referred to as “bo-po-mo-fo”). The user pronounces the desired word. The pre-processor function 24 performs normalization and filtering functions and the syllable recognizer 25 provides a recognition result for the spoken syllable by decoding it into the representation of bo-po-mo-fo. The output of the recognizer 25 is a score or a set of scores indicating the closeness of similarity between the input speech and various candidate syllables represented by bo-po-mo-fo. At a minimum, the output of the recognizer 25 is an identification of the syllable having the highest score, but alternatively the output of the recognizer 25 can be a set of syllable each having a score that exceeds a pre-determined threshold.

The search engine 28 receives from the recognizer 25 the identification or identifications of the syllable or syllables and searches the word dictionary stored in the memory 20 for all words that have the identified syllable or syllables. Typically, the number of words identified in this step is quite large (typically over a few tens) and is often too large to present this set to the user in a selection list. For more particular identification of the word desired, the digitizer 15 is used.

The users enters a stroke of the desired word using a stylus 14 (or using a finger, or by other means described below). The stroke entered by the user can be the first stroke. of each character of the desired word, or it can be the first character of the desired word. The movement of the stylus 14 across the digitizer 15 generates a pen-down input, a sequence of X and Y coordinates and a pen-up event. The X and Y coordinates are delivered to the stroke pre-processor 26, which performs functions such as smoothing, artifact removal and segmentation. These steps are described in U.S. Pat. No. 5,740,273, which is hereby incorporated by reference. The stroke recognizer 27 recognizes the intended stroke and delivers an identification to the search engine 28 identifying the recognized stroke. The search engine 28 is now able to further limit its search of the word dictionary stored in memory 20.

If, as a result of the combination of the syllable and the stroke element input to the search engine, the search engine is able to deliver a unique result, this unique result is displayed on display 22 and the user has an opportunity to confirm the identified word or cancel it and reenter it, or cancel it the stroke entry and reenter the stroke entry without canceling the syllable entry.

If the search engine 28 does not identify a unique result following the syllable entry and the first stroke entry of all the characters of the word, there are a number of alternative ways in which the operation can proceed.

If there is a small number of words identified by the search engine as a result of the syllable entry and the stroke entry, these results can be displayed in a selection list, and the user can be provided with an opportunity to strike a key or provide a pen input or a voice input that selects one of the words displayed in this selection list. Alternatively, the user can enter a next stroke of characters of the desired word, allowing the stroke recognizer 27 to deliver another stroke to the search engine 28 and allowing the search engine 28 to further limit its search of the identified words. Any number of strokes can be required as necessary to limit the search to either a unique result or a manageable list of candidates for selection.

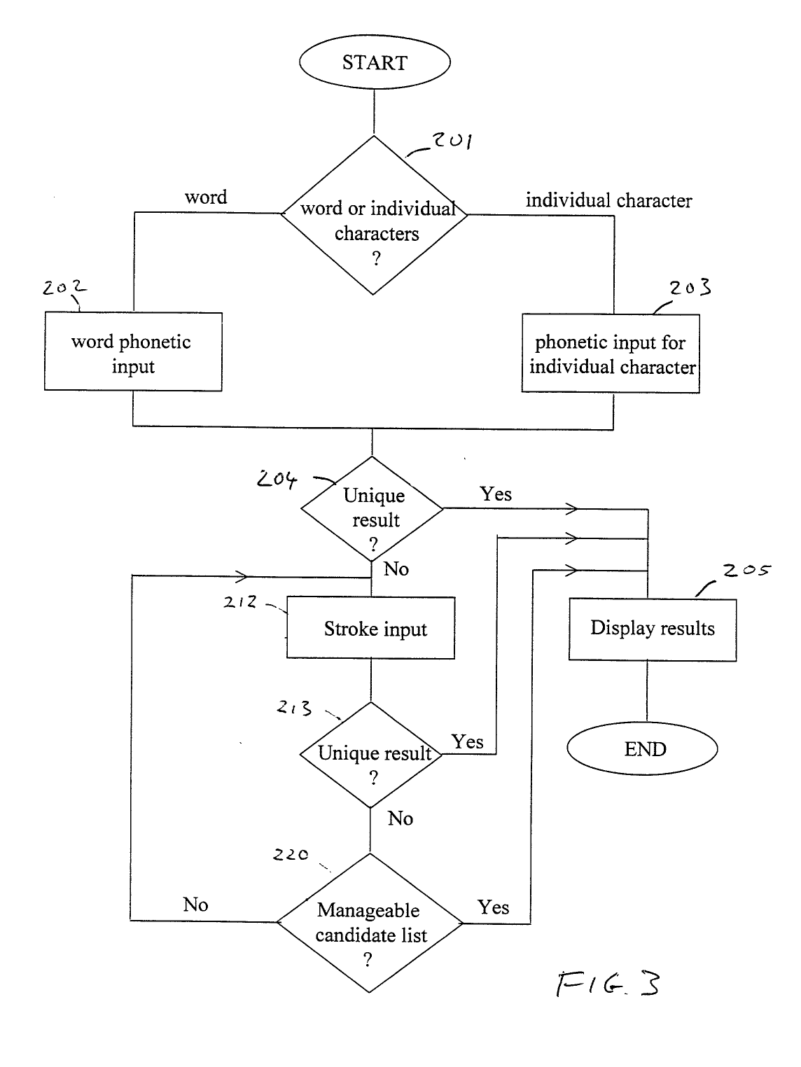

Referring to FIG. 2, the basic elements of the process performed by the microprocessor 12 are shown. At the start of a word entry in step 100, a syllable input is received (step 101) and immediately following this, a stroke input is received in step 102. If, in step 103, there is a unique result from the combination of the syllable input and the stroke input, this result is displayed in step 104 and the process ends at step 105. If, following step 102, there is a set of results that correspond to the combination of the syllable input and the stroke input, the process returns to step 102 for additional stroke input and step 102 can be repeated as many times as are necessary to provide a unique result.

One skilled in the art will identify that the process of FIG. 2 can be improved in a number of ways that are not strictly material to the invention. For example, after a stroke has been entered, if no result is delivered, this indicates that the stroke is not of correct type. In other words, there is no word in the dictionary that corresponds to the combination of elements entered. The search performed by search engine 28 can be “fuzzy” in nature. For example, the syllable recognizer 25 can deliver more than one speech result and a confidence level for each result it delivers and similarly stroke recognizer 27 can deliver more than one stroke result and a confidence level for each stroke it delivers, such that search engine 28 uses different combinations of syllable elements and stroke elements, multiplying their respective confidence levels to provide a range of results spanning a spectrum of confidence levels and delivering all those results that exceed a certain confidence level, or delivering a top set of results (e.g. the top five), regardless of the absolute confidence levels.

The arrangement described can be applied to other languages in addition to Chinese, Japanese and ideographic languages. For example, it can be applied to the English language, in which case the data elements stored in memory 20 are not characters, but are multi-syllable words (or indeed can include single-syllable words). In this embodiment, the user pronounces the first syllable of a word and the search engine searches the dictionary of words for all words beginning with the syllable identified or for all words beginning with any one of a set of symbols that are identified. To further limit the search, the user enters a single character using the stylus 14 (or using a keypad which is described below). The character entered is preferably the first character of the second syllable.

By way of example, following is an expression (quoted from Sir Winston Churchill) that has thirteen words of which seven are multi-syllable: “a monstrous tyranny, never surpassed in the dark lamentable catalogue of human crime”. The multi-syllable words can be entered pronouncing the first syllable (mons, tyr, nev, sur, etc . . . ) and by entering a character of the immediately following syllable (t, a, e, p, etc . . . ) or by entering digits representative of sets of ambiguous characters (2=a, b, c; 3=d, e, f; 4=g, h, i; 5=j, k, l; 6=m, n, o; 7=p, q, r, s; 8=s, t, u, v; 9=w, x, y, z). As an alternative to entering the next immediate character of the next syllable, a different character can be selected for entry of the rest of a multi-syllable word, e.g. the next consonant (which in this example would be t, n, r, p, etc . . . ) or the last consonant (s, y, r, d, etc . . . ).

The above example provides a saving in keystrokes vis-à-vis character entry for every chara/cter and a saving in processing vis-à-vis speech processing of every syllable. The saving is more significant in the Chinese langu,age.

Instead of using a stylus and digitizer as the stroke-input device, other mechanical input devices can be substituted. For example, a simple keypad can be used of nine keys (for more keys or fewer keys). If Chinese is the language being entered, each key of the keypad can represent a stroke or a class of strokes as described in co-pending patent application Ser. No. 09/220,308 of Wu et al. filed on Dec. 23, 1998 and assigned to the assignee of the present invention, which is hereby incorporated by reference. If, the language being entered is based on the Roman alphabet, a keypad can be used in which each key represents a plurality of letters of the alphabet, as described in co-pending patent application Ser. No. 08/754,453.

An alternative input device is a device such as a joystick or mouse button, which is finger operated and allows a user to enter a compass-point stroke (or a complex stroke that has several compass-point segments), as described in the above co-pending patent application of Wu et al. Another possible input device is one that has multiple buttons and detects movement of a finger across the buttons, as described in co-pending patent application Ser. No. 09/032,123 of Panagrossi filed on Feb. 27, 1998.

Other embodiments and modifications of the invention can render the device by one of ordinary skill in the art following from the teachings of the invention and all such embodiments and modifications are within the scope and spirit of the invention.

What is claimed is:

1. A method of data entry comprising:
accepting a voice input representing a first phonetic component of a data element;
accepting a mechanical input representing at least one writing component of the data element; and
identifying the desired data element from the voice input and the at least one writing component.

2. The method of claim 1, wherein the step of accepting the voice input comprises receiving and identifying a bo-po-mo-fo phonetic element, which is a start element of a phonetic representation of a Chinese character.

3. The method of claim 2, wherein the step of accepting a mechanical input comprises accepting a key input from a set of keys.

4. The method of claim 3, wherein the step of accepting the key input comprises accepting a key input from a keypad having a plurality of keys wherein each key represents a class of handwritten strokes.

5. The method of claim 1, wherein the step of accepting a mechanical input comprises accepting a first stroke of a character.

6. The method of claim 4, wherein the step of accepting a mechanical input comprises accepting a first stroke of a second component of a data element where the second component follows a first component that is identified by the phonetic component.

7. The method of claim 1, wherein the step of accepting a mechanical input comprises accepting and recognizing a stroke input from a two-dimensional stroke input device.

8. The method of claim 1, wherein the step of identifying comprises searching a pre-stored set of data elements according to the first phonetic component and the at least one writing component.

9. The method of claim 8 further comprising accepting at least one further mechanical input representing at least one further writing component to uniquely identify a desired data element when the step of identifying does not deliver a unique result.

10. A data entry device comprising:
an audio input for receiving a phonetic component of a data element;
a mechanical input for receiving at least one writing component of a data element;
a storage element having stored therein a representation of a plurality of data elements; and
a search engine for searching the storage element for at least one data element represented by the phonetic component and the writing component.

11. The data entry device of claim 10, wherein the mechanical input is a set of keys.

12. The data entry device of claim 11, wherein each key of the set keys represents a class of strokes of handwriting input.

13. The data entry device of claim 10, wherein the mechanical input is a digitizer for accepting two-dimensional strokes from a writing element.

14. The data entry device of claim 10, wherein the mechanical input is a finger-operated element moveable in two dimensions.
